(19) United States
(12) Patent Application Publication
(10) Pub. No.: US 2013/0043986 A1
(43) Pub. Date: Feb. 21, 2013

(54) REMOTE CONTROLLER AND REMOTE CONTROL METHOD USING SAME HAVING TWO CONTROL MODES FOR CONTROLLING AT LEAST TWO DIFFERENT HOUSEHOLD ELECTRIC APPLIANCES

(71) Applicants: AN-AN PAN, Shenzhen City (CN); RUI-PING ZHOU, Shenzhen City (CN); YONG ZHANG, Shenzhen City (CN); SHIH-FANG WONG, Tu-Cheng (TW); TSUNG-JEN CHUANG, Tu-Cheng (TW)

(72) Inventors: AN-AN PAN, Shenzhen City (CN); RUI-PING ZHOU, Shenzhen City (CN); YONG ZHANG, Shenzhen City (CN); SHIH-FANG WONG, Tu-Cheng (TW); TSUNG-JEN CHUANG, Tu-Cheng (TW)

(73) Assignees: HON HAI PRECISION INDUSTRY CO., LTD., Tu-Cheng (TW); Fu Tai Hua Industry (Shenzhen) Co., Ltd., ShenZhen City (CN)

(21) Appl. No.: 13/326,339

(22) Filed: Dec. 15, 2011

(30) Foreign Application Priority Data
Aug. 19, 2011 (CN) 201110239219.3

(51) Int. Cl. G05B 11/01

(52) U.S. Cl. 340/12.52

(57) ABSTRACT

A remote controller includes a processor, a display unit, a input unit, a communicator. The processor is configured to generate a mode interface. The display unit is configured to display the mode interface. The input unit is configured to generate control commands under the condition that a user presses the input unit according to the mode interface displayed on the display unit. The processor generates a plurality of remote control signals according to the control commands and transmits the remote control signals to a communicator. The communicator is configured to emit remote control signals to at least two electric appliances to control at least two electric appliances. A remote control method using the remote controller is also provided.

### BACKGROUND

1. Technical Field

The present disclosure relates to remote controllers and a remote control method using the same, and more particularly, to a remote controller and a remote control method using the same having two control modes for controlling at least two different household electric appliances.

2. Description of Related Art

A household electric appliance may have a remote control device for remotely controlling the household electric appliance. These remote control devices can only control one designated and predetermined household electrical appliance. This may cause confusion, as in an example when a user has several different household electric appliances and different corresponding remote control devices.

Thus, a new remote control device is desired to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a remote controller according to one embodiment of the present disclosure.

FIG. 2 is a flowchart showing a remote control method according to one embodiment of the present disclosure using the remote controller of FIG. 1, the remote control method includes a first mode interface, a first sub-interface, a second mode interface, and a second sub-interface.

FIG. 3 is a schematic diagram of the first mode interface and the first sub-interface used in the remote control method of FIG. 2 according to one embodiment.

FIG. 4 is a schematic diagram of the second mode interface and the second sub-interface used in the remote control method of FIG. 2 according to one embodiment.

FIG. 5 is a flowchart showing a method for setting or initializing the first mode interface and the second mode interface of FIG. 3 or the first sub-interface and the second sub-interface of FIG. 4 according to one embodiment.

### DETAILED DESCRIPTION

Reference will now be made to the drawings to describe various inventive embodiments of the present disclosure in detail, wherein like numerals refer to like units throughout.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

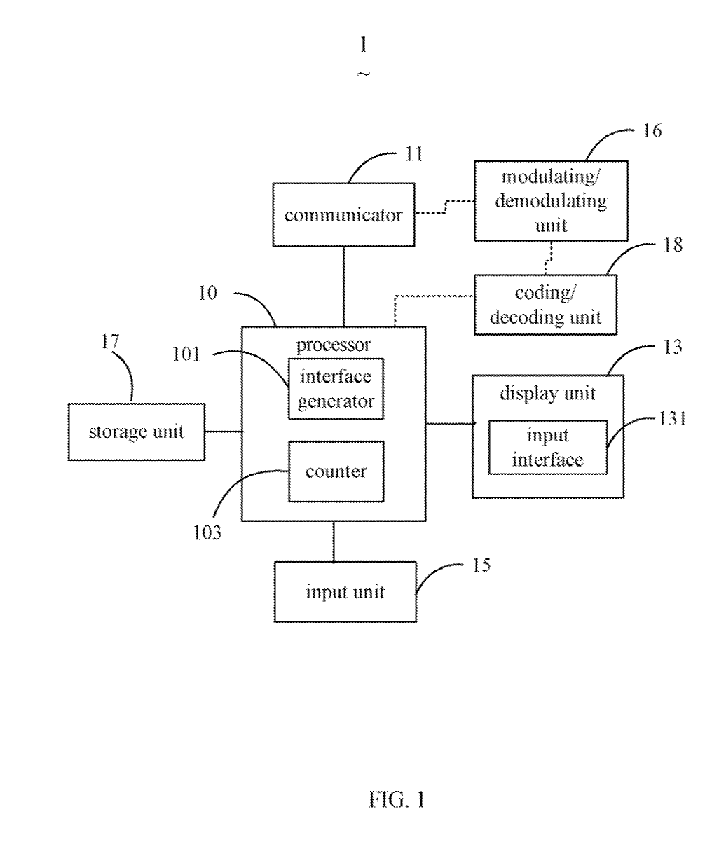

Referring to FIG. 1, a block diagram of a remote controller 1 according to one embodiment of the present disclosure is shown. The remote controller 1 may be a mobile phone with a touch display. In one embodiment, the remote controller 1 can normally work as a typical mobile phone as an ordinary skill knows and can also specially works as a remote controller configured to control at least two different household electric appliances as described below.

In one embodiment, the remote controller 1 includes a processor 10, a communicator 11, a display unit 13, an input unit 15, a modulating/demodulating unit 16, a coding/decoding unit 18, and a storage unit 17. The processor 10 is electrically connected to the communicator 11, the display unit 13, the input unit 15, and the storage unit 17.

In one embodiment, the communicator 11 may include a wireless communication function selected from the group consisting of GSM communication, CDMA communication, WIFI communication, BLUETOOTH communication, or infrared communication. The communicator 11 is configured to emit remote control signals to control operation of the household electric appliances or receive remote control signals from a predetermined remote control device of the household electric appliances (e.g., a remote control device from the manufacture of a specific household electric appliance).

The storage unit 17 is configured to store the remote control signals for controlling the household electric appliances, a plurality of text boxes, symbols, images or icons defined as object buttons relating to different household electric appliances, and a plurality of text boxes, symbols, images or icons defined as function buttons relating to the remote control signals to control operation of the household electric appliances. The storage unit 17 is also configured to store a first relationship between first object buttons and the household electric appliances and a second relationship between the function buttons and the remote control signals to control operation of the household electric appliances, and a third relationship between second object buttons and the remote control signals to control operation of the household electric appliances. In one embodiment, the storage unit 17 may be read-only memory (ROM) or Erasable Programmable Read-Only Memory (EPPROM) or other memory devices.

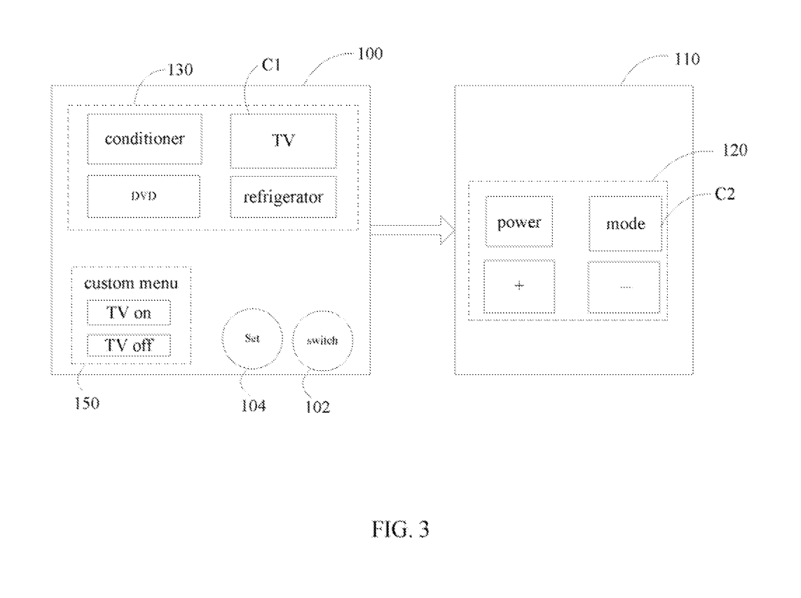

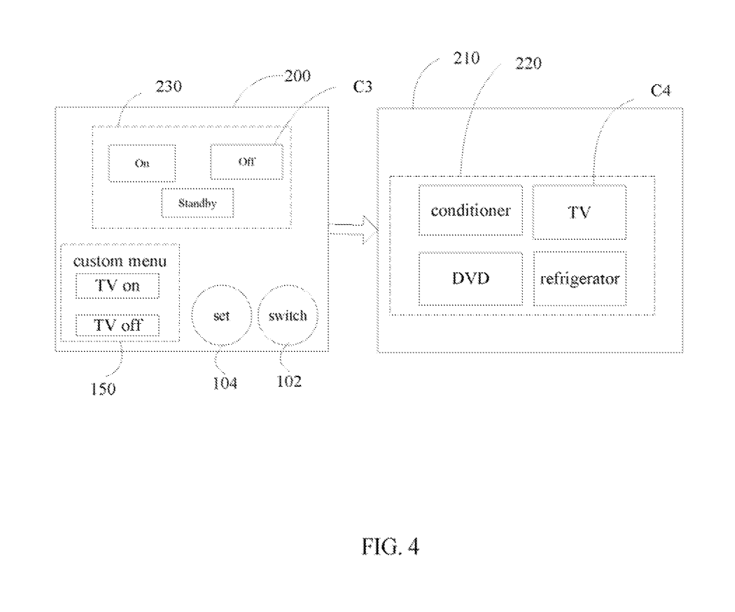

In this embodiment, the processor 10 includes an interface generator 101. The interface generator 101 is configured to generate an input interface 131 as shown in FIG. 1. The interface generator 101 is also configured to generate a first mode interface 100 and a first sub-interface 110 as shown in FIG. 3. The interface generator 101 is further configured to generate a second mode interface 200 and a second sub-interface 210 as shown in FIG. 4. The first mode interface 100, the first sub-interface 110, the second mode interface 200, and the second sub-interface 210 include a plurality of function buttons or a plurality of object buttons. The interfaces may include computerized code in the form of one or more programs that are stored in the storage unit 17. The computerized code includes computer-readable program code (instructions) that are executed by the processor 10 to provide touch control functions of the remote controller 1.

The display unit 13 is configured to receive and display the input interface 131 and the first mode interface 100 as shown in FIG. 1. The display unit 13 is also configured to receive and display the second mode interface 200, the first sub-interface 110, or the second sub-interface 210 as shown in FIG. 3 through FIG. 4. The function buttons and object buttons of the interfaces displayed on the display unit 13 can be controlled by the user to generate a plurality of control commands.

In this embodiment, the input unit 15 is a touch panel attached to the display unit 13. The input unit 15 is configured to generate a control command when the user presses the input unit 15 with his finger according to one of the function buttons or the object buttons displayed on the display unit 13. The input unit 15 is also configured to generate control commands or input information when the user presses the input unit 15 with his finger according to the input interface 131. In an alternative embodiment, the input unit 15 may further include one or more physical buttons arranged beside the display unit 13. When receiving a control command from the input unit 15, the processor 10 performs a function relating to the control command.

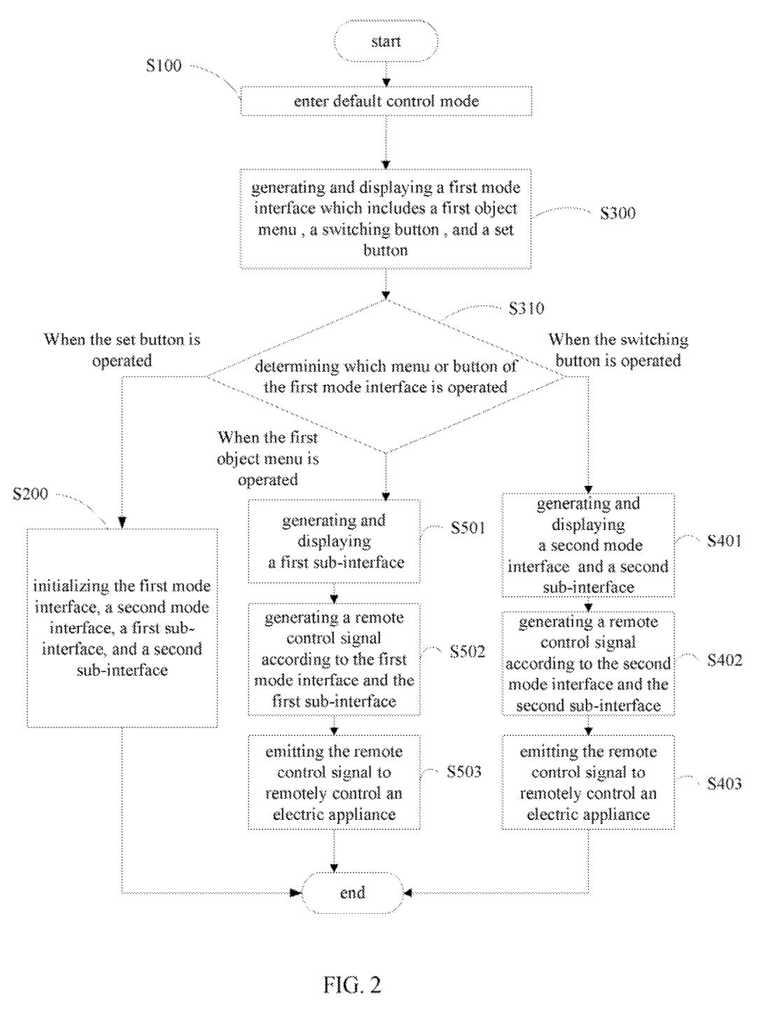

Referring to FIG. 2, a flowchart showing a remote control method for using the remote controller 1 according to one embodiment of the present disclosure is provided. The remote control method includes the following steps, but it should be understood that in other embodiments, additional steps may be added, others deleted, and the ordering of the steps may be changed.

In step S100, a start up command is input from the input unit 15 to allow the remote controller 1 to enter an object control mode or a function control mode. In this embodiment, the object control mode is defined to be a default control mode and the remote controller 1 always enters the object control mode when the start up command is input from the input unit 15. In an alternative embodiment, the function control mode may be defined to be the default control mode and the remote controller 1 always enters the object control mode when the start up command is input from the input unit 15.

In step S300, in the object control mode, the processor 10 first generates the first mode interface 100 and displays the first mode interface 100 on the display unit 13. The first mode interface 100 includes a first object menu 130, a switch button 102, a set button 104, and a custom menu 150 as shown in FIG. 3.

The first object menu 130 includes a plurality of first object buttons C1 each relating to one household electric appliance. In this embodiment, the first object buttons C1 are four text boxes “conditioner”, “TV”, “DVD”, and “refrigerator” as shown in FIG. 3 respectively relating to an air conditioner, a television, a DVD player, and a refrigerator of the user. In an alternative embodiment, the text boxes may be replaced by small icons or symbols of the air conditioner, the television, the DVD player, and the refrigerator.

In step S310, the processor 10 determines which menu or button of the first mode interface 100 is pressed or operated by the user. When the first object menu is operated, steps S501-S503 will be sequentially performed. When the switching button is operated, steps S401-S403 will be sequentially performed. When the set button is operated, step S200 will be performed.

In step S501, when one of the first object button C1 is pressed by the user, a first sub-interface command is generated and sent to the processor 10 by the input unit 15. The processor 10 generates a first sub-interface 120 and displays the first sub-interface 120 on the display unit 13 for replacing the first mode interface 100 according to the first sub-interface command. The first sub-interface 120 includes a plurality of first function buttons C2 taken from the storage unit 17 as shown in FIG. 3. The first function buttons C2 are defined as a first function menu 110. Each first function button C2 is relating to a remote control action to the household electric appliance and configured to generate a function adjusting command of the corresponding household electric appliance. In an alternative embodiment, the first function menu 110 can also be displayed beside the first object menu 130 within the first mode interface 100 to omit the first sub-interface 120.

In step S502, in this embodiment, when one of the first function buttons C2 is pressed by the user, the first adjusting command is generated and sent to the processor 10 by the input unit 15. The processor 10 generates a remote control signal and transmits the remote control signal to the communicator 11 according to the adjusting command.

In step S503, the communicator 11 emits the remote control signal to the corresponding household electric appliance to perform the remote control action. In an alternative embodiment, the remote control signal is modulated and coded by the modulating/demodulating unit 16 and the coding/decoding unit 18, before the communicator 11 receives the remote control signal.

In one embodiment, when the user wants to control his/her refrigerator and presses the text box “refrigerator”, the first sub-interface 120 is generated by the processor 10 and displayed on the display unit 13 as shown in FIG. 2. The first function buttons C2 of this first sub-interface 120 include two text boxes “power”, “mode”, and two symbols “+” and “−”. The first function button of “power” is pressed to remotely turn on or turn off the user's refrigerator. The first function button of “mode” is pressed to remotely select an operation mode of the user's refrigerator. The first function buttons of “+” and “−” are pressed to remotely adjust the output temperature of the user's refrigerator.

The custom menu 150 includes one or more speed buttons each relating to an often used remote control action to one household electric appliance or other electrical device capable of be remote controlled. In one embodiment, the processor 10 further includes a counter 103 as shown in FIG. 1 to count a using frequency of each first function button C2. The first function buttons C2 with greater frequency are automatically defined to be the speed buttons 150 by the processor 10. In one embodiment, the custom menu 150 includes two text boxes “TV on”, “TV off” as shown in FIG. 3 and FIG. 4.

The switch button 102 is pressed to allow the remote controller 1 change from the object control mode into the function control mode, or change from the function control mode into the object control mode. In this embodiment, when the switch button 102 is pressed by the user, a mode change command is generated and sent to the processor 10 by the input unit 15. The remote controller 1 enters the function control mode when the processor 10 receives the mode change command.

In the function control mode, in step S401, the processor 10 generates the second mode interface 200, thereby displaying the second mode interface 200 on the display unit 13 in the function control mode. The second mode interface 200 includes a second function menu 230, the switch button 102, the set button 104, and the custom menu 150.

The second function menu 230 includes a plurality of second function buttons C3 each relating to at least two similar remote control actions to different household electric appliances. In this embodiment, the second function buttons C3 are three text boxes “On”, “Off”, and “Standby”, as shown in FIG. 4, respectively relating to actions of turning on, turning off, and standby of the different household electric appliances.

When one of the second function buttons C3 is pressed by the user, a second sub-interface command is generated and sent to the processor 10 by the input unit 15. The processor 10 generates the second sub-interface 210, thereby displaying the second sub-interface 210 on the display unit 13 for replacing the second mode interface 200 according to the second sub-interface command.

The second sub-interface 210 includes a second object menu 220 having a plurality of second object buttons C4. The second object buttons C4 are relating to similar remote control actions of different household electric appliances and configured to generate function adjusting commands of the corresponding household electric appliances. In an alternative embodiment, the second object menu 220 can also be displayed beside the second function menu 230 within the second mode interface 200 to omit the second sub-interface 210.

In this embodiment, in step S402, when one of the second object buttons C4 is pressed by the user, a second adjusting command is generated and sent to the processor 10 by the input unit 15. The processor 10 generates a remote control signal and transmits the remote control signal to the communicator 11 according to the second adjusting command.

In step S401, the communicator 11 emits the remote control signal to the corresponding household electric appliance to perform the remote control action. In one embodiment, when the user wants to turn on his refrigerator, TV, television, and DVD player substantially at the same time, the user first presses the text box “On” of the second function buttons C3. The second sub-interface 210 is generated by the processor 10 and displayed on the display unit 13 as shown in FIG. 4. The second object buttons C4 of this second sub-interface 210 include four text boxes “conditioner”, “TV”, “DVD”, and “refrigerator” as shown in FIG. 4. The second object button of “conditioner” is pressed to remotely turn on the user's conditioner. The second object button of “TV” is pressed to remotely turn on the user's television. The second object button of “DVD” is pressed to remotely turn on the user's DVD player. The second object button of “refrigerator” is pressed to remotely turn on the user's refrigerator.

In the function control mode, the user first touches one second function button C3 according to a common or similar remote control action, then touches the second object buttons C4 of the different household electric appliances that the user wanted to remote control. Thus, selected household electric appliances may be controlled to perform a similar or common remote control action substantially at the same time for fewer touch actions to the input unit 15.

In step S200, a setting method is performed to initialize the first mode interface 100, the second mode interface 200, the first sub-interface 110, and the second sub-interface 210 when the set button 104 is pressed by the user. The setting method is configured to create a first relationship between the first object buttons and the household electric appliances and a second relationship between the function buttons and the control signals of controlling the corresponding household electric appliances, and a third relationship between the second object buttons and the remote control signals to control operation of the household electric appliances.

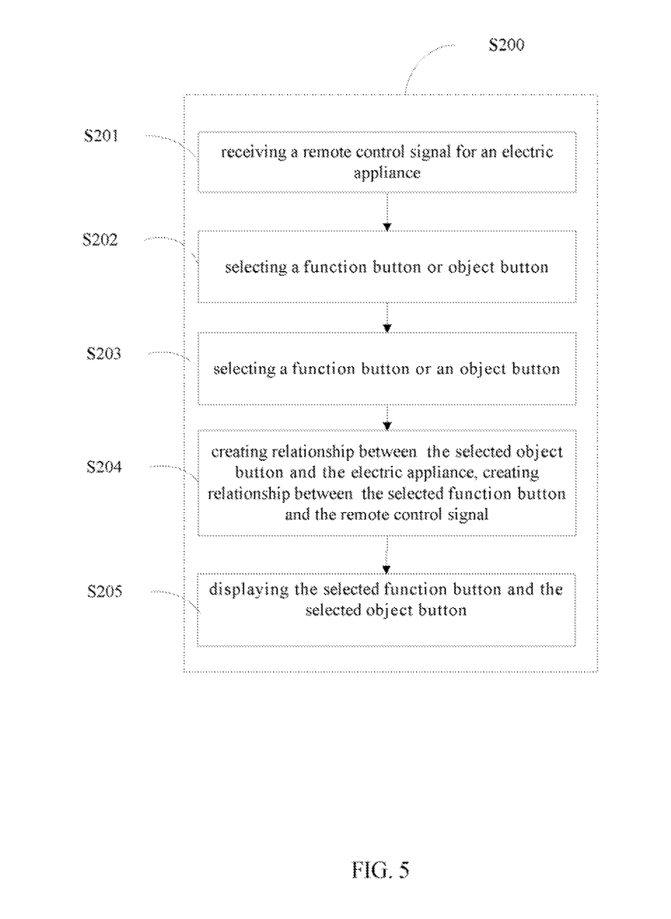

Referring to FIG. 5, the setting method is described in detail as following. The method includes the following steps, but it should be understood that in other embodiments, additional steps may be added, others deleted, and the ordering of the steps may be changed.

In step S201, a remote control signal for remotely controlling a household electric appliance is emitted from a remote control device of the household electric appliance. In this embodiment, the remote control device is originally provided to remotely control operation of the household electric appliance when the household electric appliance is sold to a customer or user. The remote control signal from the remote control device is then received by the communicator 11 and is directly transmitted to the processor 10 by the communicator 11. In an alternative embodiment, the remote control signal is demodulated and decoded by the modulating/demodulating unit 16 and the coding/decoding unit 18, before the processor 10 receives the remote control signal.

In step S202, the processor 10 receives the remote control signal and stores the control signal into the storage unit 17.

In step S203, a function button or an object button is selected from the storage unit 17 by the processor 10. In this embodiment, the function button and the object button can be selected from the group consisting of text boxes, symbols, images or icons and are pre-stored in the storage unit 17. In an alternative embodiment, the function button and the object button can be text boxes and input via the input interface 131 of the input unit 15 by the user. In one embodiment of the object control mode, when the remote control signal is represented to turn on a television of the user. The first function button and the first object button can be set to text boxes of “On” and “TV”, respectively. In this step, the speed buttons of the custom menu 150 can be set similar to the first function button and the first object button. In one embodiment of the function control mode, when the remote control signal is represented to turn on a television of the user. The second function button and the second object button can be set to text boxes of “On” and “TV”, respectively.

In step S204, a first relationship between the selected first object button and the selected household electric appliance is created by the processor 10 and stored into the storage unit 17. A second relationship between the selected first function button and the remote control signal for controlling the selected corresponding household electric appliance is also created by the processor 10 and stored into the storage unit 17. A third relationship between the second object buttons and the remote control signals to control operation of the household electric appliances is further created by the processor 10 and stored into the storage unit 17.

In step S205, the selected first or second function button and the selected first or second object buttons are respectively displayed on the second mode interface 200 and the second sub-interface 210 or the first sub-interface 110 and the first mode interface 100. After that, the set button 104 is pressed again by the user to confirm the selected first or second function button and the selected first or second object button and finish the setting method.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A remote controller, comprising:
a processor configured to generate a mode interface;
a display unit configured to display the mode interface;
an input unit configured to generate control commands under the condition that a user presses the input unit according to the mode interface displayed on the display unit; and
a communicator configured to emit remote control signals to at least two electric appliances to control operation of the at least two electric appliances, wherein the remote control signals are generated and transmitted to the communicator by the processor according to the control commands.

2. The remote controller of claim 1, wherein the mode interface comprises a first mode interface to be displayed on the display unit, the first mode interface comprises a first object menu, a switch button, a set button, and a custom menu.

3. The remote controller of claim 2, wherein the first object menu comprises a plurality of first object buttons displayed on the display unit, each object button relating to one of the at least two electric appliances.

4. The remote controller of claim 3, wherein the first object buttons are four text boxes indicative of text that corresponds to four different electric appliances.

5. The remote controller of claim 3, wherein the mode interface further comprises a first sub-interface to be displayed on the display unit, the first sub-interface comprises a first function menu, the first sub-interface is generated by the processor when the user presses the input unit according to one of the plurality of first object buttons displayed on the display unit.

6. The remote controller of claim 5, wherein the first function menu comprises a plurality of first function buttons each relating to a remote control action to one of the at least two electric appliances, and the control commands are generated under the condition that the user presses the input unit according to first function buttons displayed on the display unit.

7. The remote controller of claim 6, wherein the mode interface comprises a second mode interface, the second mode interface comprises a second function menu, the switch button, the set button, and the custom menu.

8. The remote controller of claim 7, wherein the second function menu comprises a plurality of second function buttons each relating to similar remote control actions to the at least two electric appliances.

9. The remote controller of claim 8, wherein the mode interface further comprises a second sub-interface to be displayed on the display unit, the second sub-interface comprises a second object menu, the second sub-interface is generated by the processor when the user presses the input unit according to one of the plurality of second function buttons displayed on the display unit.

10. The remote controller of claim 9, wherein the second object menu comprises a plurality of second object buttons relating to similar remote control actions of the at least two electric appliances.

11. The remote controller of claim 10, wherein the plurality of first and second function buttons and the plurality of first and second object buttons are selected from the group consisting of text boxes, symbols, images and icons.

12. The remote controller of claim 10, wherein the switch button is configured to exchange between the first mode interface and the second mode interface.

13. The remote controller of claim 10, wherein the custom menu comprises one or more speed buttons displayed on the display unit each relating to an often used remote control action to the at least two electric appliances.

14. The remote controller of claim 10, wherein the set button is configured to perform a setting method for initializing the first mode interface, the second mode interface, the first sub-interface, and the second sub-interface.

15. The remote controller of claim 14, wherein a first relationship between the first object buttons and the electric appliances, a second relationship between the first function buttons and the remote control signals, and a third relationship between the second object buttons and the remote control signals to control operation of the at least two household electric appliances are created in the setting method.

16. The remote controller of claim 15, further comprising a storage unit configured to store the remote control signals, the relationships and the text boxes, symbols, images or icons.

17. The remote controller of claim 1, wherein the processor comprises an interface generator configured to generate the mode interface.

18. The remote controller of claim 17, wherein the interface generator further generates an input interface displayed on the display unit, the input unit is configured to generate control commands or input information when the user presses the input unit displayed on the display unit according to the input interface.

19. A remote control method comprising:
generating a mode interface by a processor;
displaying the mode interface by a display unit;
generating control commands under the condition that a user presses an input unit according to the mode interface displayed on the display unit; and
generating remote control signals by the processor according to the control commands;
transmitting the remote control signals to a communicator; and
emitting remote control signals to at least two electric appliances to control operation of the at least two electric appliances by the communicator.

20. The remote control method of claim 19, wherein the mode interface includes a first mode interface for entering an object control mode and a second mode interface for entering a function control mode, the remote control method further comprises a process of exchanging the first mode interface and the second mode interface.
